(19) United States
(12) Patent Application Publication
(10) Pub. No.: US 2022/0282659 A1
(43) Pub. Date: Sep. 8, 2022

(54) Air-Cooled Diesel Generator

(71) Applicant: JIANGSU GOLD DRAGON POWER CO., LTD., Yangzhou City (CN)

(72) Inventors: Zhipeng Wang, Yangzhou City (CN); Yingying Liu, Yangzhou City (CN); Wenhao Zhu, Yangzhou City (CN)

(73) Assignee: JIANGSU GOLD DRAGON POWER CO., LTD., Yangzhou City (CN)

(21) Appl. No.: 17/473,023

(22) Filed: Sep. 13, 2021

(30) Foreign Application Priority Data
Mar. 5, 2021 (CN) 202110243873.5

(51) Int. Cl. F01P 5/06; F02B 77/13; F02B 63/04

(52) U.S. Cl. CPC F01P 5/06; F02B 77/13; F02B 63/044; F01P 2001/005

(57) ABSTRACT

An air-cooled diesel generator is provided, and relates to the technical field of diesel generator sets. The air-cooled diesel generator comprises a box body and multiple components provided in the box body, and each component is provided with a separate housing outside; a main air inlet and a main air outlet are formed in the box body, a sub-air inlet and a sub-air outlet are formed in each housing, each sub-air outlet communicates with the main air outlet through an air duct, and each sub-air inlet is provided with an air guide device. Therefore, the air-cooled diesel generator is provided which has better heat dissipation performance.

### CROSS REFERENCE TO RELATED APPLICATION

This patent application claims the benefit and priority of Chinese Patent Application No. 202110243873.5, entitled “air-cooled diesel generator” filed with the Chinese Patent Office on Mar. 5, 2021, which is incorporated herein by reference in its entirety.

### TECHNICAL FIELD

The present disclosure relates to the technical field of diesel generator sets, and in particular to an air-cooled diesel generator set.

### BACKGROUND ART

Existing diesel generator sets on the market each comprise a box body, although the box body can play a role in protecting all components in the diesel generator set, the corresponding box body can also limit heat dissipation of all components of the diesel generator set, and thus the phenomenon that heat is accumulated in the box body and cannot be dissipated once the diesel generator set runs for a long time occurs. Also, the service life of the diesel generator is influenced, and even potential safety hazards exist; and for most sets, the intake air are natural air, thereby resulting in a poor heat dissipation effect.

### SUMMARY

The present disclosure aims to provide an air-cooled diesel generator to solve the problem in the prior art and to improve the heat dissipation performance of the air-cooled diesel generator.

To achieve the purpose, the present disclosure provides the following technical solutions:

The present disclosure provides an air-cooled diesel generator, which comprises a box body and multiple components provided in the box body, and each component is provided with a separate housing outside; a main air inlet and a main air outlet are formed in the box body; a sub-air inlet and a sub-air outlet are formed in each housing, each sub-air outlet communicates with the main air outlet through an air duct, and each sub-air inlet is provided with an air guide device.

Preferably, the main air inlet and the main air outlet are each provided with an isolation net.

Preferably, the main air inlet and the main air outlet are each provided with a louver.

Preferably, the box body is provided with sound-absorbing cotton.

Preferably, the maximum size of a hole on the isolation net is 12 mm.

Preferably, the air guide device is a draught fan.

Preferably, the air-cooled diesel generator comprises at least two components, and the two components are a diesel engine and a generator respectively.

Preferably, the air duct is made of a thermal insulation material.

Preferably, a number of the main air inlets is two.

Compared to the prior art, the present disclosure has the following technical effects:

The present disclosure provides an air-cooled diesel generator, where each component is correspondingly provided with a separate air duct to convey hot air in a housing, the heat interference among the components is small, and an air guide device is provided as a power source to make external air, air in a box body, and air in the housing circulate, to improve the heat dissipation efficiency of the air-cooled diesel generator, and thus, the air-cooled diesel generator provided by the present disclosure has better heat dissipation performance.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIGURE is a structure diagram of an air-cooled diesel generator provided by the present disclosure;

Reference signs in drawing: 1 box body, 2 diesel engine, 3 generator, 4 main air outlet, 5-main air inlet, 6 air guide device, 7 air duct.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure aims to provide an air-cooled diesel generator to solve the problem in the prior art and to improve the heat dissipation performance.

To make the above objects, features, and advantages of the present disclosure more apparent, the present disclosure will be described in further detail below with reference to the accompanying drawings and detailed description of the embodiments.

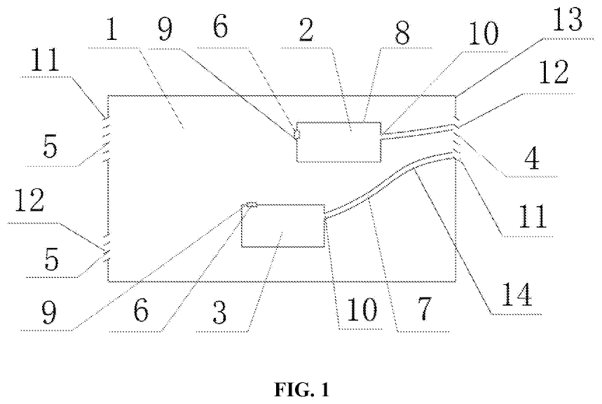

The present disclosure provides an air-cooled diesel generator, which is adapt for a silent rainproof box for a high-power air-cooled diesel generator set with a V-shaped cylinder. As shown in FIG. 1, the air-cooled diesel generator comprises a box body 1 and a plurality of components provided in the box body 1, and an outside of each component is provided with a separate housing; a main air inlet 5 and a main air outlet 4 are formed in the box body 1; a sub-air inlet and a sub-air outlet are formed in each housing, each sub-air outlet communicates with the main air outlet 4 through an air duct 7, and each sub-air inlet is provided with an air guide device 6.

Where each component is correspondingly provided with a separate air duct 7 to convey hot air in the housing, the heat interference among the components is small, and the air guide device 6 is provided as a power source to make external air, air in the box body 1, and air in the housing circulate, to improve the heat dissipation efficiency of the device, and thus, the air-cooled diesel generator provided by the present disclosure has better heat dissipation performance.

Further, in order to prevent impurity particles from entering the box body 1 through the main air inlet 5 and the main air outlet 4, the main air inlet 5 and the main air outlet 4 are each provided with an isolation net.

Further, in order to prevent rainwater from entering the box body 1 through the main air inlet 5 and the main air outlet 4, the main air inlet 5 and the main air outlet 4 are each provided with a louver.

Further, in order to prevent excessive noise, the box body 1 is provided with sound-absorbing cotton, and the sound-absorbing cotton can absorb noise generated by the generator set.

Further, the maximum size of a hole on the isolation net is 12 mm to filter impurities with size larger than 12 mm.

Further, the air guide device 6 is a draught fan, and the draught fan is used to introduce the air in the box body 1 into the housing and exhaust the air in the housing out of the box body 1 through the air duct 7.

Further, the air-cooled diesel generator comprises at least two components, and the two components are a diesel engine 2 and a generator 3 respectively.

Further, in order to enhance anti-interference capability among the components, the air duct 7 is made of a thermal insulation material, and the air duct 7 is fixed in the box body 1 through a support frame.

Further, a number of the main air inlets is two.

Specific examples are used in the present disclosure to set forth the principles and embodiments of the present disclosure. The above description of the embodiments is merely used to help understand the method of the present disclosure and its core thought; and meanwhile, for a person of ordinary skill in the art, changes may be made in both specific embodiments and scope of application in accordance with the thought of the present disclosure. Therefore, the specification shall not be construed as a limitation on the present disclosure.

1. An air-cooled diesel generator, comprising: a box body and a plurality of components provided in the box body, wherein each component is provided with a separate housing outside; a main air inlet and a main air outlet are formed in the box body; a sub-air inlet and a sub-air outlet are formed in each housing, each sub-air outlet communicates with the main air outlet through an air duct, and each sub-air inlet is provided with an air guide device;
wherein the main air inlet and the main air outlet are each provided with an isolation net;
a maximum size of a hole on the isolation net is 12 mm.

2. (canceled)

3. The air-cooled diesel generator according to claim 1, wherein the main air inlet and the main air outlet are each provided with a louver.

4. The air-cooled diesel generator according to claim 1, wherein the box body is provided with sound-absorbing cotton.

5. (canceled)

6. The air-cooled diesel generator according to claim 1, wherein the air guide device is a draught fan.

7. The air-cooled diesel generator according to claim 1, wherein the air-cooled diesel generator comprises at least two components, and the two components are a diesel engine and a generator respectively.

8. The air-cooled diesel generator according to claim 1, wherein the air duct is made of a thermal insulation material.

9. The air-cooled diesel generator according to claim 1, wherein a number of main air inlets is two.
